(19) United States
(12) Patent Application Publication
(10) Pub. No.: US 2026/0012229 A1
(43) Pub. Date: Jan. 8, 2026

(54) SOLUTIONS AND SIGNALING TO ENABLE CELL-FREE MULTIPLE INPUT MULTIPLE OUTPUT TRANSMISSION

(71) Applicant: Nokia Technologies Oy, Espoo (FI)

(72) Inventors: Tao YANG, Shanghai (CN); Hao LIU, Shanghai (CN); Nuan SONG, Shanghai (CN); Yan ZHAO, Shanghai (CN); Pingping WEN, Shanghai (CN)

(21) Appl. No.: 18/993,661

(22) PCT Filed: Jul. 18, 2022
(86) PCT No.: PCT/CN2022/106302

§ 371 Date: Jan. 13, 2025

(51) Int. Cl. H04B 7/0413

(52) U.S. Cl. CPC H04B 7/0413

(57) ABSTRACT

Systems, methods, apparatuses, and computer program products for enabling efficient cell-free MIMO transmissions. One method may include receiving a downlink reference signal, determining at least one cell-free multiple input multiple output transmission strategy associated with at least one access point based upon at least the downlink reference signal, and transmitting to a network entity at least one of the at least one cell-free multiple input multiple output transmission strategy and enabling information.

### TECHNICAL FIELD

Some example embodiments may generally relate to mobile or wireless telecommunication systems, such as Long Term Evolution (LTE), fifth generation (5G) radio access technology (RAT), new radio (NR) access technology, sixth generation (6G), and/or other communications systems. For example, certain example embodiments may relate to systems and/or methods for enabling efficient cell-free multiple input multiple output (MIMO) transmissions.

### BACKGROUND

Examples of mobile or wireless telecommunication systems may include radio frequency (RF) 5G RAT, the Universal Mobile Telecommunications System (UMTS) Terrestrial Radio Access Network (UTRAN), LTE Evolved UTRAN (E-UTRAN), LTE-Advanced (LTE-A), LTE-A Pro, NR access technology, and/or MulteFire Alliance. 5G wireless systems refer to the next generation (NG) of radio systems and network architecture. A 5G system is typically built on a 5G NR, but a 5G (or NG) network may also be built on E-UTRA radio. It is expected that NR can support service categories such as enhanced mobile broadband (eMBB), ultra-reliable low-latency-communication (URLLC), and massive machine-type communication (mMTC). NR is expected to deliver extreme broadband, ultra-robust, low-latency connectivity, and massive networking to support the Internet of Things (IoT). The next generation radio access network (NG-RAN) represents the RAN for 5G, which may provide radio access for NR, LTE, and LTE-A. It is noted that the nodes in 5G providing radio access functionality to a user equipment (e.g., similar to the Node B in UTRAN or the Evolved Node B (eNB) in LTE) may be referred to as next-generation Node B (gNB) when built on NR radio, and may be referred to as next-generation eNB (NG-eNB) when built on E-UTRA radio.

### SUMMARY

In accordance with some example embodiments, a method may include receiving, by a user equipment, a downlink reference signal. The method may further include determining, by the user equipment, at least one cell-free multiple input multiple output transmission strategy associated with at least one access point based upon at least the downlink reference signal. The method may further include transmitting, by the user equipment, to a network entity at least one of the at least one cell-free multiple input multiple output transmission strategy and enabling information.

In accordance with certain example embodiments, an apparatus may include means for receiving a downlink reference signal. The apparatus may further include means for determining at least one cell-free multiple input multiple output transmission strategy associated with at least one access point based upon at least the downlink reference signal. The apparatus may further include means for transmitting to a network entity at least one of the at least one cell-free multiple input multiple output transmission strategy and enabling information.

In accordance with various example embodiments, a non-transitory computer readable medium may be encoded with instructions that may, when executed in hardware, perform a method. The method may include receiving a downlink reference signal. The method may further include determining at least one cell-free multiple input multiple output transmission strategy associated with at least one access point based upon at least the downlink reference signal. The method may further include transmitting to a network entity at least one of the at least one cell-free multiple input multiple output transmission strategy and enabling information.

In accordance with some example embodiments, a computer program product may perform a method. The method may include receiving a downlink reference signal. The method may further include determining at least one cell-free multiple input multiple output transmission strategy associated with at least one access point based upon at least the downlink reference signal. The method may further include transmitting to a network entity at least one of the at least one cell-free multiple input multiple output transmission strategy and enabling information.

In accordance with certain example embodiments, an apparatus may include at least one processor and at least one memory including computer program code. The at least one memory and the computer program code may be configured to, with the at least one processor, cause the apparatus to at least receive a downlink reference signal. The at least one memory and the computer program code may be further configured to, with the at least one processor, cause the apparatus to at least determine at least one cell-free multiple input multiple output transmission strategy associated with at least one access point based upon at least the downlink reference signal. The at least one memory and the computer program code may be further configured to, with the at least one processor, cause the apparatus to at least transmit to a network entity at least one of the at least one cell-free multiple input multiple output transmission strategy and enable information.

In accordance with various example embodiments, an apparatus may include circuitry configured to receive a downlink reference signal. The circuitry may further be configured to determine at least one cell-free multiple input multiple output transmission strategy associated with at least one access point based upon at least the downlink reference signal. The circuitry may further be configured to transmit to a network entity at least one of the at least one cell-free multiple input multiple output transmission strategy and enable information.

In accordance with some example embodiments, a method may include transmitting, by a network entity, at least one downlink reference signal to a user equipment. The method may further include receiving, by the network entity, at least one cell-free multiple input multiple output transmission strategy based upon the at least downlink reference signal from the user equipment. The method may further include determining, by the network entity, a role of each of a plurality of access points based upon at least one of the strategy and enabling information from the user equipment. The method may further include transmitting, by the network entity, an indication of an association between each of the plurality of access points and the strategy to the user equipment.

In accordance with certain example embodiments, an apparatus may include means for transmitting at least one downlink reference signal to a user equipment. The apparatus may further include means for receiving at least one cell-free multiple input multiple output transmission strategy based upon the at least downlink reference signal from the user equipment. The apparatus may further include means for determining a role of each of a plurality of access points based upon at least one of the strategy and enabling information from the user equipment. The apparatus may further include means for transmitting an indication of an association between each of the plurality of access points and the strategy to the user equipment.

In accordance with various example embodiments, a non-transitory computer readable medium may be encoded with instructions that may, when executed in hardware, perform a method. The method may include transmitting at least one downlink reference signal to a user equipment. The method may further include receiving at least one cell-free multiple input multiple output transmission strategy based upon the at least downlink reference signal from the user equipment. The method may further include determining a role of each of a plurality of access points based upon at least one of the strategy and enabling information from the user equipment. The method may further include transmitting an indication of an association between each of the plurality of access points and the strategy to the user equipment.

In accordance with some example embodiments, a computer program product may perform a method. The method may include transmitting at least one downlink reference signal to a user equipment. The method may further include receiving at least one cell-free multiple input multiple output transmission strategy from the user equipment. The method may further include determining a role of each of a plurality of access points based upon at least one of the strategy and enabling information from the user equipment. The method may further include transmitting an indication of an association between each of the plurality of access points and the strategy to the user equipment.

In accordance with certain example embodiments, an apparatus may include at least one processor and at least one memory including computer program code. The at least one memory and the computer program code may be configured to, with the at least one processor, cause the apparatus to at least transmit at least one downlink reference signal to a user equipment. The at least one memory and the computer program code may be further configured to, with the at least one processor, cause the apparatus to at least receive at least one cell-free multiple input multiple output transmission strategy from the user equipment. The at least one memory and the computer program code may be further configured to, with the at least one processor, cause the apparatus to at least determine a role of each of a plurality of access points based upon at least one of the strategy and enabling information from the user equipment. The at least one memory and the computer program code may be further configured to, with the at least one processor, cause the apparatus to at least transmit an indication of an association between each of the plurality of access points and the strategy to the user equipment.

In accordance with various example embodiments, an apparatus may include circuitry configured to transmit at least one downlink reference signal to a user equipment. The circuitry may further be configured to receive at least one cell-free multiple input multiple output transmission strategy from the user equipment. The circuitry may further be configured to determine a role of each of a plurality of access points based upon at least one of the strategy and enabling information from the user equipment. The circuitry may further be configured to transmit an indication of an association between each of the plurality of access points and the strategy to the user equipment.

### BRIEF DESCRIPTION OF THE DRAWINGS

For a proper understanding of example embodiments, reference should be made to the accompanying drawings, wherein:

FIG. 1 illustrates an example of a general cell-free MIMO architecture.

FIG. 2 illustrates an explanatory description on an uplink signaling architecture.

FIG. 3 illustrates an example of a signaling diagram according to certain example embodiments.

FIG. 4 illustrates an explanatory example of uplink signaling to report the role of each access point.

FIG. 5 illustrates an example of coherent joint transmission.

FIG. 6 illustrates an example of non-coherent joint transmission.

FIG. 7 illustrates examples of coherent joint transmission and non-coherent joint transmission.

FIG. 8 illustrates an example of a flow diagram of a method according to various example embodiments.

FIG. 9 illustrates another example of a flow diagram of a method according to various example embodiments.

FIG. 10 illustrates an example of various network devices according to some example embodiments.

FIG. 11 illustrates an example of a 5G network and system architecture according to certain example embodiments.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for enabling efficient cell-free MIMO transmissions is not intended to limit the scope of certain example embodiments, but is instead representative of selected example embodiments.

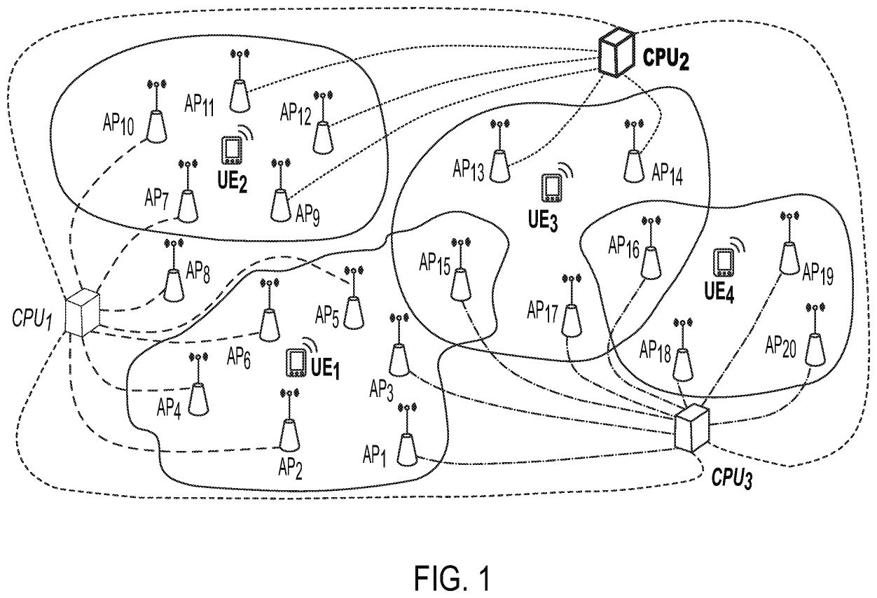

FIG. 1 depicts a general network architecture of cell-free MIMO transmission. Cell-free MIMO is one of many 6G features that may provide high system capacity at both sub-6G and millimeter wave (mmW) frequency bands. The network side shown in FIG. 1 can include at least two types of nodes: access point (AP) and central processing unit (CPU). The functionalities of AP and CPU nodes continue to be developed, especially on the layer 1 (L1) procedures split between them.

One important feature of cell-free MIMO is that more than one AP may serve user equipment (UE) for both UL and downlink (DL) communication, and the selection of APs to improve UE communication continues to be developed, particularly with static cluster and/or UE-centric dynamic cluster schemes. Regarding static cluster schemes, pre-defined APs connecting to the same CPU may be configured to serve some or all UEs within a pre-defined area, regardless of the channel quality between the APs and the subject UE. For UE-centric dynamic cluster schemes, the corresponding APs may be selected to facilitate data transmissions based upon the radio quality between the UE and AP, where the list of serving AP candidates may be updated as the UE moves and/or radio channel quality changes.

Detail transmission scheme may potentially involve coherent joint transmission (CJT) and/or non-coherent joint transmission (NCJT). Similarly, cell-free MIMO transmissions may also include spatial multiplexing (SM), especially in high radio channel quality situations to improve system capacity. Each of these strategies may have different application scenarios and requirements; for example, in CJT, the APs may accurately DL synchronized with small phase errors among them such that the received signal to interference plus noise ratio (SINR) may increase on the UE side. In addition, NCJT may relax requirements for phase errors, but may require synchronization (similar to CJT) in order to ensure that DL signals from the involved APs can be received by the UE within the cyclic prefix (CP) length.

As noted above, different APs may support different transmission strategies for different situations, with the aim to provide optimal system performance. Accordingly, the network and UE may be aligned on which AP follows which transmission strategy, allowing the UE to receive data optimally and correctly. Accordingly, certain embodiments may provide for ways to provide such alignment.

Certain example embodiments described herein may have various benefits and/or advantages to overcome the disadvantages described above. For example, certain example embodiments may provide the UE with flexibility to accurately recommend an appropriate transmission strategy for each AP. If phase error information is ignored, the UE may only need to report the role of each AP, without reporting detailed information on phase errors and DL synchronization (SYN) status among all APs, thereby reducing UL signaling overhead. Furthermore, the availability of phase error information may provide important information to the network to make an appropriate CJT decision on the appropriate frequency band for optimal system performance. This may also give the UE and network enough flexibility to achieve a tradeoff between performance and signaling overhead.

In addition, the proposed architecture of certain embodiments may enable flexible hybrid cell-free MIMO transmissions, which may be suitable for UEs with multiple antenna ports and/or multiple sub-panels situation. If the UE has multiple antenna ports, the UE may recommend different transmission strategies for different antenna port simultaneously. For example, assuming a 6G UE has 3 antenna ports, the UE may recommend CJT_AP for antenna port 1, and SM_AP for antenna ports 2 and 3. This hybrid transmission strategy may enable the network to schedule transmissions optimally among APs in each serving cluster. Another example embodiment may include a UE with only one antenna/RF chain configuration, where only one data stream may be sent over the air interface per transmission time interval (TTI); in this case, the UE may only recommend one AP for per transmission, or propose multiple APs with CJT transmission. In this way, UE behaviors and UL signaling frameworks may support different UE side configurations to improve system performance. Thus, certain example embodiments discussed below are directed to improvements in computer-related technology.

Some example embodiments described herein relate to recommending and configuring an AP to use appropriate transmission strategies in time domain, either simultaneously or separately. Furthermore, certain example embodiments may define a new UL/DL signaling solution to align the network and UE on the adopted transmission strategy for the corresponding Aps for appropriate UE behavior, and enable hybrid transmission schemes among APs to achieve optimal system performance.

Various example embodiments may provide solutions and related UL/DL signals to schedule/determine an appropriate transmission strategy for each AP, and enable a corresponding alignment between the UE and network. Some example embodiments may also provide a hybrid cell-free MIMO transmission strategy, where the same or different types of cell-free MIMO transmission strategies among serving APs may be scheduled simultaneously.

The UE may initiate the procedure by requesting a DL cell-free MIMO information update from a CPU; the CPU may respond by transmitting different reference signals to UE through corresponding APs within the current serving cluster of the CPU simultaneously, so that the UE can measure the phase error information, DL SYN status information among these APs, and radio channel quality per AP.

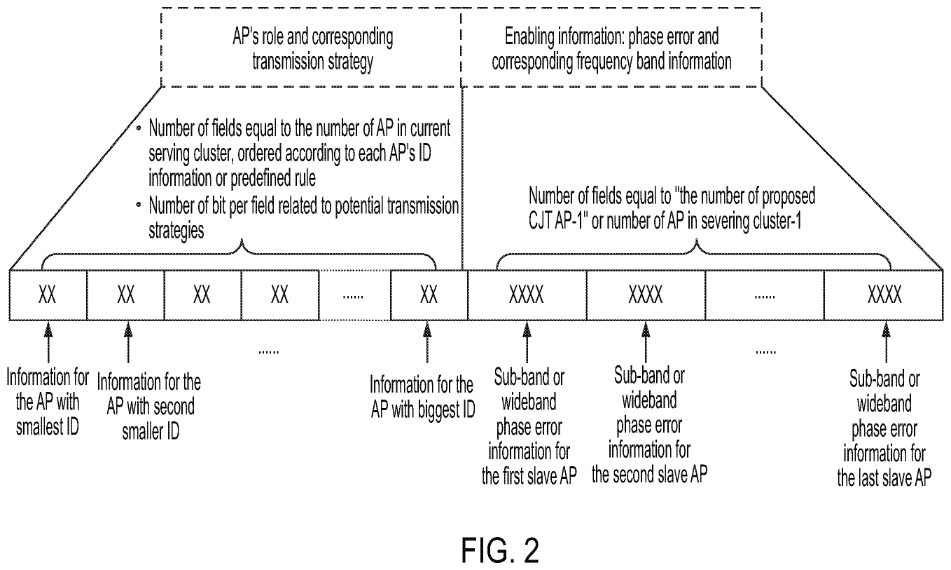

The UE may then recommend certain roles for each AP, as well as a corresponding, appropriate transmission strategy. Based on new UL signaling (example shown in FIG. 2), the UE may report the determined proposals/recommendations to the CPU, specifically, which APs will apply which transmission strategy. In addition, the UE may report a per-sub band or wideband phase error across APs to the CPU to support a final decision by the CPU on the role of each AP.

Based on the proposals/recommendations received from the UE, and actual conditions, the CPU may make final decisions and inform the UE, for example via DL signaling, of which APs should perform which type of DL transmission. This information may then allow the UE to take appropriate actions when DL data is received.

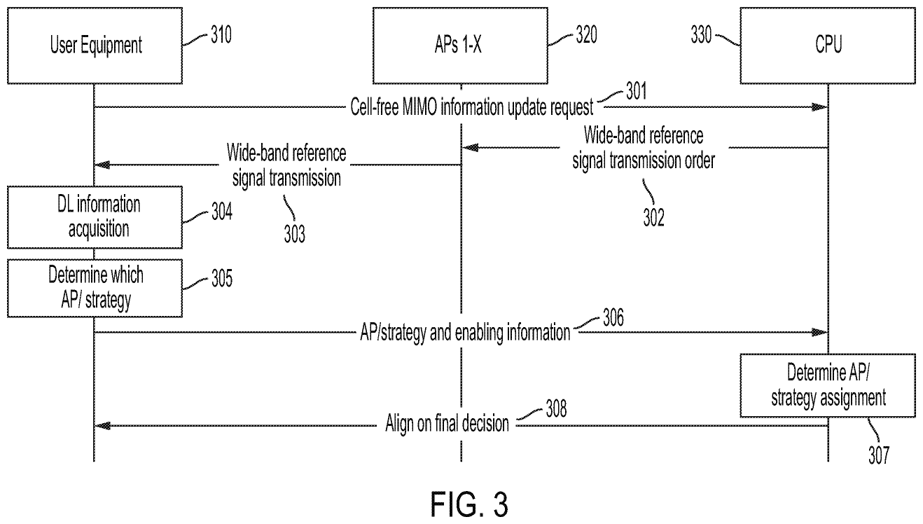

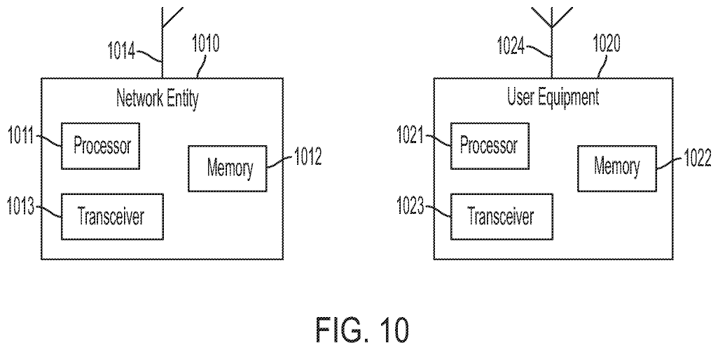

FIG. 3 illustrates an example of a signaling diagram depicting a system to enable efficient cell-free MIMO transmissions. UE 310, APs 320, and CPU 330 may be similar to NE 1010 and UE 1020, as illustrated in FIG. 10, according to certain example embodiments. As noted above, UE 310, APs 320, and CPU 330 may be configured to use multiple cell-free MIMO transmission strategies, such as CJT, NCJT, and SM. Although only one AP is illustrated, APs 320 may include any number of APs.

In various example embodiments, different types of AP sub-clusters may be dedicated to conduct different types of cell-free MIMO transmission strategies. For example, an AP_CJT sub-cluster may indicate that APs within this sub-cluster may conduct CJT transmissions, where all APs may transmit the same DL data stream to improve DL receiving SINR by UE 310. Furthermore, it may be unnecessary for UE 310 to differentiate each radio link between UE 310 and each APs 320 within this sub-cluster.

Furthermore, an AP_NCJT sub-cluster may indicate that APs 320 within this sub-cluster may conduct NCTJ transmissions, which may transmit the same DL data stream. With this sub-cluster, UE 310 may first differentiate each radio link between UE 310 and APs 320 of this sub-cluster; UE 310 may then demodulate these radio links to soft-bit levels, and combine for combining gain.

In addition, an AP_SP sub-cluster may indicate that APs within this sub-cluster conduct SM to enable multiple stream transmissions for higher throughput. For this sub-cluster, UE 310 may independently process each radio link without any combining action.

Similarly, an AP_NO sub-cluster may indicate that APs within this sub-cluster may not be scheduled to serve UE 310 within a pre-defined time period, even if the AP is within the current serving cluster. For example, the DL transmission arriving time of these APs may be outside of the CP, and may otherwise lead to significant interference. If all APs are DL SYN, this sub-cluster may not exist, and all APs in this sub-cluster may belong to one of the first three sub-clusters.

UE 310 and CPU 330 may be aligned on the serving AP cluster determination. For example, APs 320 connected to the same CPU (CPU 330) with a received RSRP above a pre-defined threshold may be selected to create a serving cluster of UE 310. Within this serving cluster, type(s) of transmission strategies appropriate for each AP may be determined based on optimal system performance.

At 301, UE 310 may transmit a request to CPU 330 for a DL cell-free MIMO transmission update. The request may be triggered, for example, due to a serving cluster update, radio channel quality change, and/or degradation of UE side decoding performance.

At 302, CPU 330 may configure and trigger different DL wide band reference signal transmissions simultaneously on APs 320 within the current serving cluster of UE 310 (i.e., AP₁₋₆ and AP₁₅ of UE₁; AP₇ and AP₉₋₁₁ of UE₂; AP₁₃₋₁₇ of UE₃; AP₁₆ and AP₁₈₋₂₀ of UE₄). In some example embodiments, before a cell-free MIMO transmission, UE 310 may select a serving cluster, for example, based upon large scale information.

At 303, CPU 330 may inform UE 310, via AP 320, of the configured DL reference signaling resource, including the frequency domain, time domain, and code domain resource so that UE 310 knows when to receive which reference signals from which APs 320. This action may be performed in advance. For example, the DL reference signal frequency resource and code domain information may be transmitted to UE 310 in advance by RRC signaling. For the time domain information notification, UE 310 and CPU 330 may be synchronized on the reference signal transmission time slot based on X+n information, where X is the time slot for UE request transmission/reception at UE 310 and APs 320, respectively, and n may be the previous configured parameter related to CPU 330 and APs 320 link transmission delay.

In various example embodiments, CPU 330 may notify UE 310 which of APs 320 is the master AP; accordingly, the non-master APs within the serving cluster may then be slave APs. This information may support UE 310 to measure and estimate the phase error between the master AP and all slave APs. CPU 330 may configure each APs 320 with different reference signals to distinguish each radio link between UE 310 and APs 320. In addition, APs 320 may be triggered to send different reference signals simultaneously, enabling UE 310 to measure the phase error among APs 320 in a simultaneous transmission situation where the measured phase error may be accurate enough to support CJT at a later stage.

At 304, UE 310 may estimate relevant information (for example, enabling information, channel quality, network load and/or resource utilization information) to use in the proposal making process (at 305), such as the phase error and radio link quality of each APs 320. Specifically, after UE 310 receives the wideband reference signal from APs 320, UE 310 may estimate the phase error among involved APs, for example, estimate the phase error between the master AP and all slave APs. For example, UE 310 may use one signal, such as the signal of the master AP, as a baseline. Phase rotation may be applied to the reference signal of each slave AP with an offset value based on a pre-defined phase offset book. Phase rotation may be performed per sub-band so that UE 310 may derive per-sub band phase error information. UE 310 may then combine, at 305, the signal of the baseline with an after phase rotation process to determine the joint signal power of them. This procedure may be repeated until all offset values of the pre-defined phase offset book are tested. In some example embodiments, “offset value” may refer to the highest joint signal power regarded as the phase error between the master AP and the corresponding slave APs on the subjected sub-band. Alternatively, UE 310 may stop the test if and when the joint signal power is above a pre-defined threshold, and the corresponding offset value may be regarded as the phase error.

By performing phase error estimation, UE 310 may accurately determine phase error per sub-band among APs 320, which may improve CJT transmissions. For example, if the biggest phase error among all sub-bands is below a pre-defined threshold, UE 310 may propose CJT transmission for those APs. Alternatively, if the smallest phase error of all sub-bands is above a pre-defined threshold, UE 310 may not propose a CJT strategy since a CJT strategy may provide minimal benefit. A per-sub band CJT proposal may be possible, wherein UE 310 and/or CPU 330 may designate CJT for one sub-band if the related phase error is below a pre-defined threshold. Furthermore, a wideband phase error may be estimated based on all sub-band phase error information, and used as the matrix for CJT decisions; if the calculated wideband phase error is below or above a pre-defined threshold, CJT and/or NCJT may be proposed.

At 306, UE 310 may transmit a proposal indicating the determined roles for each APs 320. Specifically, after UE 310 measures and calculates the phase error information, DL SYN status, and radio link quality information, UE 310 may propose a transmission strategy for APs 320 in order to optimize system performance.

For APs 320 with phase error within a preconfigured threshold, UE 310 may further determine the corresponding radio link quality to see whether a CJT or SM strategy should be proposed for these APs. For APs 320 with good radio link quality, UE 310 may coarsely estimate the corresponding throughput (assuming CJT or SM will be conducted respectively), and recommend these APs for the strategy with the higher throughput. For example, if CJT would lead to higher throughput than SM, UE 310 may recommend AP_CJT for these APs; otherwise, AP_SP may be recommended. For APs with sub-optimal radio link quality, SM may not achieve sufficient performance gain because UE 310 may not decode each radio link independently; thus, UE 310 may recommend CJT transmission for these APs to improve SINR combining gain.

For APs with small phase errors referring to the master AP, the proposal by UE 310 may cover three potential situations: AP_CJT, AP_SP or both AP_CJT and AP_SP. For both AP_CJT and AP_SP, some APs 320 may conduct CJT transmission together, while other APs may conduct SM, independently. This hybrid cell-free MIMO transmission concept may be valid for multiple antenna ports and/or sub-arrays at UE 310. For example, one antenna port may be used to receive CJT transmissions from related APs, while other ports and/or sub-arrays may be used to receive SM transmissions from other APs 320.

In various example embodiments, for APs 320 with phase error above the preconfigured threshold, CJT may not provide optimal performance gain, so UE 310 may only consider these APs 320 for NCJT or SM, which may depend on the radio link quality. For example, for APs 320 in this category, UE 310 may check the radio link quality; for APs 320 with sufficient radio link quality, UE 310 may check whether SM may improve performance gain with multiple data streams will be transmitted. If so, UE 310 may propose AP_SP for these APs 320; otherwise, UE 310 may propose AP_NCJT for these APs 320. Similarly, for APs 320 with insufficient radio link quality, UE 310 may not successfully decode each radio link independently, so UE 310 may only propose NCJT based on combine gain in order to improve successful data reception. Thus, for APs 320 with large phase errors, the proposal by UE 310 may include three potential situations: AP_NCJT, AP_SP, or both AP_NCJT and AP_SP. With AP_NCJT and AP_SP, for APs 320 within this category, UE 310 may propose AP_NCJT for some of these APs 320, and AP_SP for other APs 320.

Various example embodiments may include APs 320 where DL reception time difference of UE 310 is beyond the preconfigured CP length. For these APs 320, UE 310 may not propose that those APs 320 serve DL transmission due to potential interference. Instead, UE 310 may propose AP_NO for these APs 320; however, if all APs 320 in the serving cluster are well synchronized, AP_NO may not exist.

In some example embodiments, UE 310 may categorize all APs 320 within the current serving cluster into four categories: AP_CJT, AP_NCJT, AP_SP, and AP_NO. However, more transmission mechanisms may be possible, as well as categories for AP classification. UE 310 may recommend only one of the above four sub-clusters for each of APs 320 in the current serving cluster.

In addition, at 306, UE 310 may propose the four categories to CPU 330 explicitly for data transmission, based on UL signaling as shown in FIG. 2. If UE 310 proposes AP_CJT, UE 310 may also report to CPU 330 the corresponding phase error information for the corresponding APs 320. Alternatively, UE 310 may only report to CPU 330 phase error information of the slave APs, enabling CPU 330 to design appropriate precoding and scheduling operations to mitigate the impact of such phase errors. If the phase errors are associated with a sub-band situation, the proposals from UE 310 may also include such sub-band information. As a result, the proposals may allow CPU 330 to schedule CJT on the reported sub-band information, thereby optimizing performance for UE 310.

Some example embodiments may use appropriate UL signaling so that UE 310 may explicitly indicate the four types of AP sub-clusters to CPU 330. For example, UL signaling may be sent to CPU 330 by UL L1 or medium access control (MAC) layer signaling, depending on feedback speed required by CPU 330. For L1 UL signaling, CPU 330 may receive the proposal from UE 310 as soon as possible, and take action immediately to optimize the performance. For UL L2 signaling, CPU 330 may receive the feedback after a time delay; however, since phase error changes may not be dynamic, layer 2 (L2) signaling may be used since L1 signaling overhead may have a greater impact on UL system coverage.

In various example embodiments, UE 310 may report using a structure similar to that illustrated in FIG. 2, which may include two parts: the role of APs 320, and related enabling information. The first part may include a proposal from UE 310 on which AP should be used for data transmission on which strategy. The second part may include phase error information, which may be for APs proposed for CJT, or for all APs in the current serving cluster of UE 310. This phase error may be on a sub-band or wideband level. If the phase error is reported on a sub-band level, UE 310 may also include corresponding sub-band information in the UL report, indicating to CPU 330 which frequency band to schedule the CJT transmission.

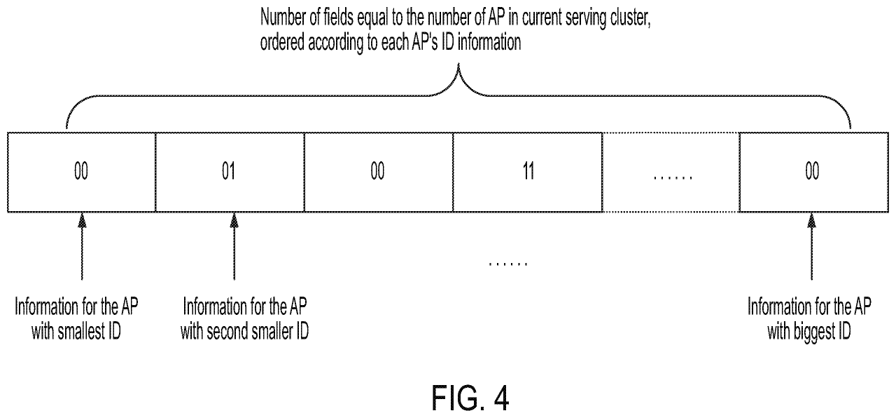

FIG. 4 illustrates an example of UL signaling to report the role of each AP. For the first part shown in FIG. 4, variable size signaling may include X number of fields, wherein X is the identifier of APs 320 in the current serving cluster. The detail value of each field may explicitly indicate the corresponding role of AP 320 in the following transmission. Bit per field may be determined by the supported cell-free MIMO transmission strategy. For example, three strategies may be supported at current stage, so a 2-bit per field may be sufficient to identify each strategy. The detail signal value of each field may correspond with a particular strategy, depending on the corresponding AP's role recommended by UE 310. For example, 00 may indicate that the corresponding AP may conduct the CJT with other APs 320 marked as “00;” 01 may indicate that the corresponding APs 320 may conduct NCJT with other APs 320 with the same value marked as “01;” 10 may indicate that the corresponding APs 320 may send dedicated data stream to UE 310; and 11 may indicate that the corresponding APs 320 will not send a data stream to UE 310 (even it is within current serving cluster).

In various example embodiments, if more transmission strategies are added to the cell-free MIMO, the number of bits per field may change as well without affecting the structure shown in FIG. 2.

The second part illustrated in FIG. 2 may include the phase error of APs recommended for CJT transmission. Alternatively, the phase error information may be reported for all slave APs, improving flexibility and providing an opportunity for CPU 330 to schedule CJT transmissions. Specifically, this phase error may be on sub-band level or wideband level. If on a sub-band level, UE 310 may include the corresponding sub-band information in this report. CPU 330 may then perform CJT scheduling on the corresponding sub-band to improve system performance. The detail design and required number of bits may vary after the decision on sub-band or wideband phase error, and phase error granularity.

UL signaling architecture may follow the examples depicted in FIGS. 2 and 4. As shown in FIG. 4, AP1, AP3, and the last AP may be the candidate to coherently transmit the same data stream to UE 310 to improve the SINR, and UE 310 may not change the corresponding radio link among these APs, but may combine signals for demodulation and decoding. Furthermore, AP4 may be recommended to not serve UE 310, possibly due to a large phase error and/or a lack of DL SYN with other APs within the current serving cluster.

At 307, after CPU 370 receives the proposals from UE 310, CPU 330 may determine the role of each of APs 320 within the recommended scope of UE 310. For example, as shown in FIG. 4, CPU 330 may consider the load and resource situations of each AP and/or side antenna port configuration of UE 310, and determine which transmission strategy(ies) may be assigned to each AP. CPU 370 may then determine the corresponding demodulation reference signal (DMRS) for each selected AP.

At 308, after making the determination in 307, CPU 330 may indicate to UE 310 its final decision to improve performance of UE 310. For example, CPU 330 may explicitly inform UE 310 of which AP will conduct which transmission strategy. For each finally selected AP, CPU 330 may explicitly or implicitly inform UE 310 of the corresponding DMRS, which may assist UE 310 with optimal behavior. For example, for those APs 320 decided for CJT, the same DMRS signal may be transmitted from these APs, and UE 310 may not need to distinguish each radio link between UE 310 and these APs. For APs to perform NCJT or SM transmissions, different DMRSs may be sent by these APs to enable UE 310 to differentiate each radio link from these APs. CPU 330 may not include APs not recommended for DL transmission in the DL signaling, thereby reducing DL signaling overhead.

In various example embodiments, DMRS configuration for each AP may enable UE 310 to correctly perform DL reception behaviors. Each AP may be configured with at least two types of DMRS in advance, such as DMRS_CJT (one DMRS common to all APs in its serving cluster) and/or DMRS_other (different DMRS per AP to enable UE to differentiate each radio link between APs 320 and UE 310).

Each DMRS configuration may be per UE level; thus, for each UE in a cell-free MIMO transmission situation, the CPU may configure (or reconfigure) these two types of DMRS based on the serving AP(s) list. In addition, the DMRS_CJT and DMRS_other definitions may mean that, before cell-free MIMO transmission, UE 310 should know which types of DMRS may be used for the following DL data reception.

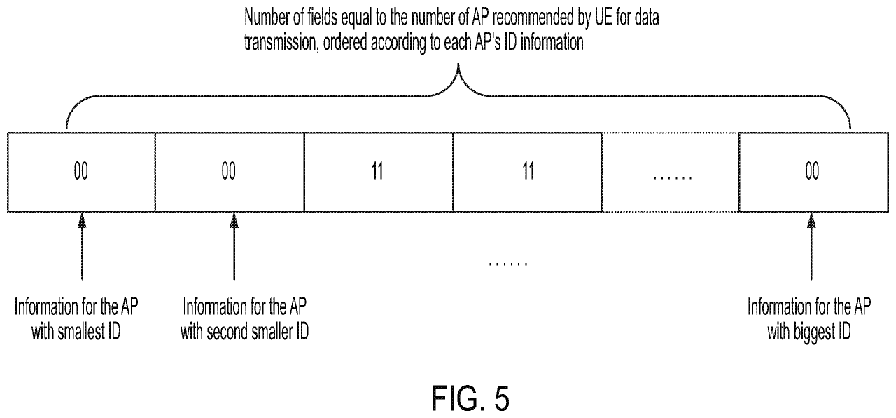

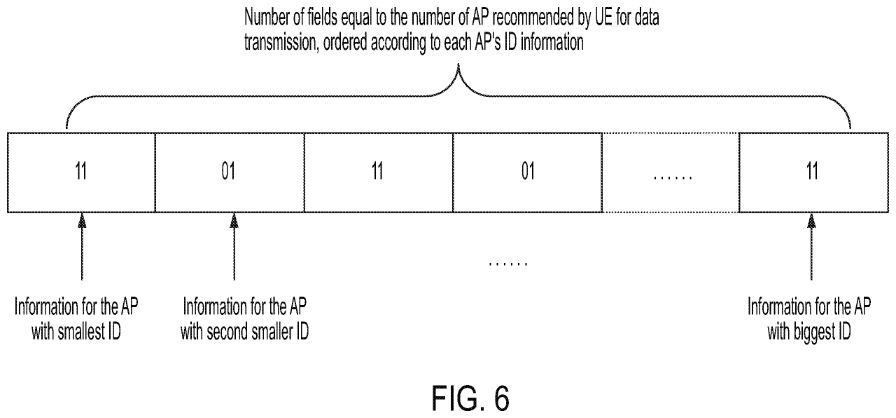

CPU 330 may need to inform UE 310 of which AP 320 may adopt which strategy by DL signaling, and may use two options (discussed in more detail that illustrated in FIG. 2 may be used to explicitly inform UE 310 which AP 320 may be involved in the following transmission and in which transmission strategy. Alternatively, the DL signaling may explicitly indicate the APs 320 to be involved in the following transmission, but implicitly indicate which transmission strategy may be used for these APs by indicating DMRS information. FIG. 5 depicts the first and last APs in a CJT sub-cluster being scheduled for DL CJT, while FIG. 6 depicts two APs being scheduled for NCJT.

In order to inform each UE explicitly, DL signaling may use an architecture similar to that depicted in FIG. 2. In this option, CPU 330 may explicitly inform UE 310 which APs 320 are selected to conduct which transmission strategy to optimize system performance. One difference from FIG. 4 is the detail signaling size may be no more than that of FIG. 4. In the DL signaling, the selected AP may be indicated within the scope of APs 320 recommended by UE 310, but may exclude those APs 320 marked as no transmission recommendation. Thus, DL signaling may include Y number of 2-bit fields, where Y is equal to the number of AP number recommended by UE 310, excluding those APs marked as “11.” Each 2-bit field may indicate the corresponding AP's transmission strategy. 2-bit per AP may be used since no more than 3 cell-free MIMO transmission strategies may be supported. However, more transmission strategies may be added with more bits designed to indicate each AP's situation without affecting the DL signaling architecture.

When informing UE 310 explicitly, CPU 330 may mark APs 320 as “11,” which is within the recommendation scope of UE 310, but not selected for transmission. Thus, some APs may be recommended by UE 310 for DL transmission, but not ultimately selected by CPU 330 for various reasons. CPU 330 may inform UE 310 of this information so that UE 310 knows from which AP 320 to receive the DL transmission in which mechanism.

Furthermore, informing each UE explicitly may enable decoding of the DL signaling since UE 310 is aware of the Y information based on its previous recommendation. Specifically, based on the previous UL signal of UE 310, UE 310 may know the value of Y in advance, and then correctly decode the DL signaling to improve data demodulation and decoding. The DL signaling architecture is shown in FIGS. 5 and 6.

In FIG. 5, the CPU may make a final decision that the first, second, and last AP may jointly send the same data stream to the UE coherently. After the UE decodes this DL signaling, the UE may know that the same DMRS_CJT will be sent from the first, second, and last APs, and may not receive DMRS from other APs. The UE may combine the DL transmissions from these APs to do perform receiving operations.

In FIG. 6, the UE may know that only two APs are sending the same data stream jointly to the UE non-coherently, and different DMRS may be sent from these two APs. The UE may not attempt to decode information from other APs since they are marked as “11,” and not receive data transmissions from them. UE 310 may distinguish two radio links from these two APs by different DMRS. UE 310 may then demodulate these two radio links independently to soft-bit levels, and combine to improve combining gain and decoding performance. This may enable UE 310 to clearly identify which AP 320 will use which transmission strategy, and perform optimal receiving functions.

Although the above two examples only indicate one transmission strategy per TTI, such a signaling structure may be very flexible to indicate hybrid transmission strategy in time domain. For example, some APs can jointly send the same data streams to UE 310 coherently. Furthermore, some APs may send the same data stream to UE 310 non-coherently, and may even support SM. This may depend on the number of antenna ports configured at UE 310 to support one or multiple data stream reception.

Another benefit of explicit DL signaling is that CPU 330 may have enough flexibility to finally determine which AP 320 should use which transmission strategy. For example, according to the proposal by UE 310, some APs 320 may be recommended for NCJT due to their big phase errors. However, if such phase errors are known to CPU 330 (for example, based on reported phase error information by UE 310), CPU 330 may help to compensate for such phase error with the precoding operation. Any such APs may be configured for CJT, which may differ from the recommendations by UE 310. Instead, CPU 330 may indicate any differences to UE 310. Despite the cost of more DL signaling overhead, each role of APs 320 may be indicated. If such DL signaling is sent by L2 MAC signaling, such overhead may be minimal.

Explicit indications enable indicating one transmission strategy per TTI, but such signaling structure may also be flexible to indicate hybrid transmission strategies in time domain. For example, some APs may jointly transmit the same data streams to UE 310 coherently. In addition, some APs may send the same data stream to UE 310 non-coherently and support SM. This may depend on the number of antenna ports configured at UE 310 to support one or multiple data stream reception.

In addition, explicit indications may provide CPU 320 with flexibility to determine which AP 320 should use which transmission strategy. For example, according to the recommendation by UE 310, some APs 320 may be recommended for NCJT due to phase errors among them. If phase errors are known by CPU 330, for example, based on UE 310 reported phase error information, CPU 330 may help to compensate for such phase errors with precoding operations. Such APs 320 may be configured for CJT, which may be different from recommendations by UE 310. For this situation, CPU 330 may clearly indicate such differences to UE 310. The cost of more DL signaling overhead may clearly indicate the role of each AP. If such DL signaling is sent via L2 MAC signaling, such overhead may be insignificant.

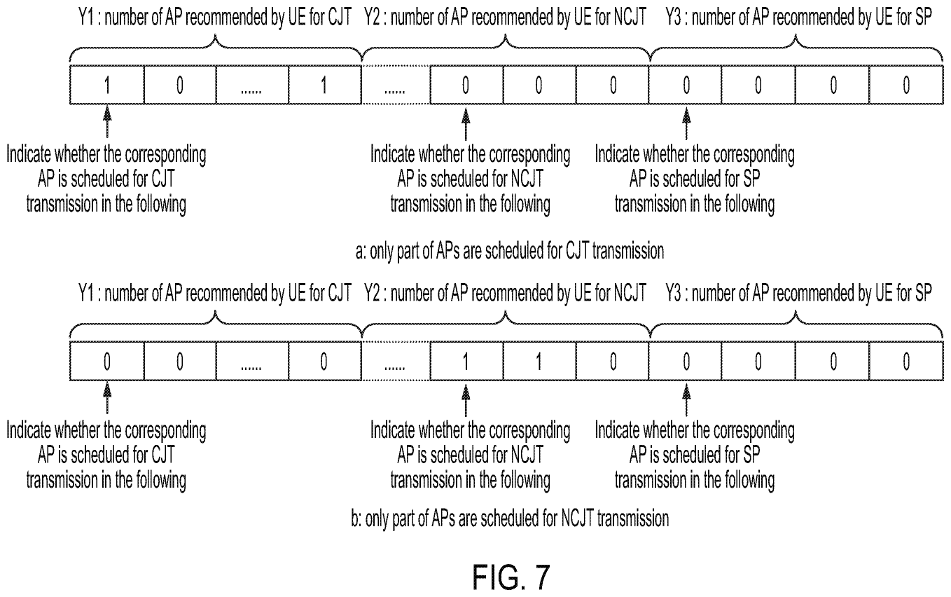

With implicit DMRS signaling, 2-bit signal content for each field may indicate the corresponding AP 320 assigned with which transmission strategy; UE 310 may then implicitly know which types of DMRS will be sent from these APs 320 for following actions. The cost for such signaling may be 2*Y-bit signaling size to get enough flexibility for selecting APs for any types of transmission. While using implicit DMRS signaling, the recommendation by UE 310 may be followed for each APs 320 role, and CPU 330 may only a make final decision on which APs 320 will be involved in the following transmission; there may not be any operation to change the role of APs 320. This option may also be valid and feasible since UE 310 understands phase error information of each AP 320, DL SYN status, and DL channel status information. UE 310 may recommend roles of APs 320 that are solid and accurate enough for either CJT, NCJT, SM, or no transmission. In addition, CPU 330 may not try to change the recommended role for each AP 320, but make a final decision of whether each AP 320 will be scheduled for transmission or not. For this option, the DL signaling design (shown in FIG. 7) may only indicate that each AP 320 will be scheduled or not.

As shown in FIG. 7, the DL signaling design may include multiple sections based on recommendations from UE 310, with each section referring to APs recommended by UE 310 for CJT, NCJT, and SM, respectively. Each section may include a number of fields equal to the AP number of the corresponding transmission strategy recommended by UE 310 before. The detail value may be 1-bit per field to indicate the corresponding AP 320 is scheduled for the transmission or not. For example, if this bit is “1”, that means the corresponding AP is scheduled to take the UE recommended transmission strategy. On the other hand, the corresponding AP may not be incorporated into the following transmission. The total DL signal size may be Y bits, where Y is the number of APs that UE 310 recommended for transmission.

The technique depicted in FIG. 6 may improve receiving behavior of UE 310, and may support hybrid transmission strategy execution in time domain, but with half of the signaling size compared to the technique depicted in FIG. 5. One benefit of using implicit DMRS signaling with the cost that CPU may not change the role of AP 320 recommended by UE 310. Since the recommendation by UE 310 may be based on its accurate DL information, this cost may be minimal.

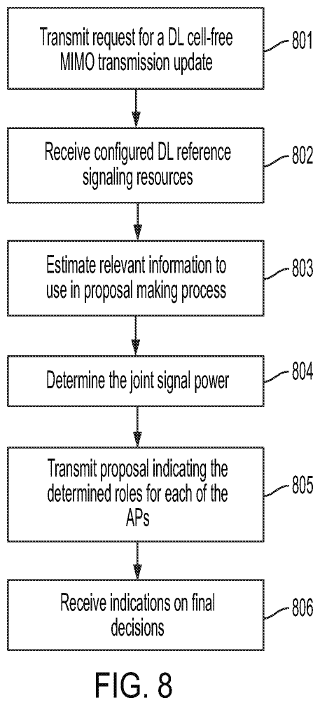

FIG. 8 illustrates an example of a flow diagram of a method that may be performed by a UE, such as UE 1020 illustrated in FIG. 10, according to various example embodiments.

As noted above, the UE, and APs and a CPU (such as NE 1010 illustrated in FIG. 10), may be configured to use multiple cell-free MIMO transmission strategies, such as CJT, NCJT, and SM. Although only one AP is illustrated, any number of APs may be included.

In various example embodiments, different types of AP sub-clusters may be dedicated to conduct different types of cell-free MIMO transmission strategies. For example, an AP_CJT sub-cluster may indicate that APs within this sub-cluster may conduct CJT transmissions, where all APs may transmit the same DL data stream to improve DL receiving SINR by the UE. Furthermore, it may be unnecessary for the UE to differentiate each radio link between the UE and each AP within this sub-cluster.

Furthermore, an AP_NCJT sub-cluster may indicate that the APs within this sub-cluster may conduct NCTJ transmissions, which may transmit the same DL data stream. With this sub-cluster, the UE may first differentiate each radio link between the UE and the APs of this sub-cluster; the UE may then demodulate these radio links to soft-bit levels, and combine for combining gain.

In addition, an AP_SP sub-cluster may indicate that APs within this sub-cluster conduct SM to enable multiple stream transmissions for higher throughput. For this sub-cluster, the UE may independently process each radio link without any combining action.

Similarly, an AP_NO sub-cluster may indicate that APs within this sub-cluster may not be scheduled to serve the UE within a pre-defined time period, even if the AP is within the current serving cluster. The DL transmission arriving time of these APs may be outside of the CP, and may otherwise lead to significant interference. If all APs are DL SYN, this sub-cluster may not exist, and all APs in this sub-cluster may belong to one of the first three sub-clusters.

The UE and the CPU may be aligned on the serving AP cluster determination. For example, the APs connected to the same CPU with a received RSRP above a pre-defined threshold may be selected to create a serving cluster of the UE. Within this serving cluster, type(s) of transmission strategies appropriate for each AP may be determined based on optimal system performance.

At 801, the method may include transmitting a request to the CPU for a DL cell-free MIMO transmission update. The request may be triggered, for example, due to a serving cluster update, radio channel quality change, and/or degradation of UE side decoding performance.

At 802, the method may include receiving, from the CPU via an AP, configured DL reference signaling resources, including the frequency domain, time domain, and code domain resource so that the UE knows when to receive which reference signals from which the APs. This action may be performed in advance. For example, the DL reference signal frequency resource and code domain information may be transmitted to the UE in advance by RRC signaling. For the time domain information notification, the UE and the CPU may be synchronized on the reference signal transmission time slot based on X+n information, where X is the time slot for UE request transmission/reception at the UE and the APs, respectively, and n may be the previous configured parameter related to the CPU and the APs link transmission delay.

In various example embodiments, the CPU may notify the UE which of the APs is the master AP; accordingly, the non-master APs within the serving cluster may then be slave APs. This information may support the UE to measure and estimate the phase error between the master AP and all slave APs. The CPU may configure each of the APs with different reference signals to distinguish each radio link between the UE and the APs. In addition, the APs may be triggered to send different reference signals simultaneously, enabling the UE to measure the phase error among the APs in a simultaneous transmission situation where the measured phase error may be accurate enough to support CJT at a later stage.

At 803, the method may include estimating relevant information (for example, enabling information, channel quality, network load and/or resource utilization information) to use in its proposal making process (at 804), such as the phase error and radio link quality of each the APs. Specifically, after the UE receives the wideband reference signal from the APs, the UE may estimate the phase error between the master AP and all slave APs. For example, the UE may use one signal, such as the signal of the master AP, as a baseline. Phase rotation may be applied to the reference signal of each slave AP with an offset value based on a pre-defined phase offset book. Phase rotation may be performed per sub-band so that the UE may derive per-sub band phase error information.

At 804, the method may include combining the signal of the baseline with an after phase rotation process to determine the joint signal power of them. This procedure may be repeated until all offset values of the pre-defined phase offset book are tested.

In some example embodiments, “offset value” may refer to the highest joint signal power regarded as the phase error between the master AP and the corresponding slave APs on the subjected sub-band. Alternatively, the UE may stop the test if and when the joint signal power is above a pre-defined threshold, and the corresponding offset value may be regarded as the phase error.

By performing phase error estimation, the UE may accurately determine phase error per sub-band among the APs, which may improve CJT transmissions. For example, if the biggest phase error among all sub-bands is below a pre-defined threshold, the UE may propose CJT transmission for those APs. Alternatively, if the smallest phase error of all sub-bands is above a pre-defined threshold, the UE may not propose a CJT strategy since a CJT strategy may provide minimal benefit. A per-sub band CJT proposal may be possible, wherein the UE and/or the CPU may designate CJT for one sub-band if the related phase error is below a pre-defined threshold. Furthermore, a wideband phase error may be estimated based on all sub-band phase error information, and used as the matrix for CJT decisions; if the calculated wideband phase error is below or above a pre-defined threshold, CJT and/or NCJT may be proposed.

At 805, the UE may transmit a proposal indicating the determined roles for each of the APs. Specifically, after the UE measures and calculates the phase error information, DL SYN status, and radio link quality information, the UE may propose a transmission strategy for the APs in order to optimize system performance.

For the APs with phase error within a preconfigured threshold, the UE may further determine the corresponding radio link quality to see whether a CJT or SM strategy should be proposed for these APs. For the APs with good radio link quality, the UE may coarsely estimate the corresponding throughput (assuming CJT or SM will be conducted respectively), and recommend these APs for the strategy with the higher throughput. For example, if CJT would lead to higher throughput than SM, the UE may recommend AP_CJT for these APs; otherwise, AP_SP may be recommended. For APs with sub-optimal radio link quality, SM may not achieve sufficient performance gain because the UE may not decode each radio link independently; thus, the UE may recommend CJT transmission for these APs to improve SINR combining gain.

For APs with small phase errors referring to the master AP, the proposal by the UE may cover three potential situations: AP_CJT, AP_SP or both AP_CJT and AP_SP. For both AP_CJT and AP_SP, some of the APs may conduct CJT transmission together, while other APs may conduct SM, independently. This hybrid cell-free MIMO transmission concept may be valid for multiple antenna ports and/or sub-arrays at the UE. For example, one antenna port may be used to receive CJT transmissions from related APs, while other ports and/or sub-arrays may be used to receive SM transmissions from the other APs.

In various example embodiments, for the APs with phase error above the preconfigured threshold, CJT may not provide optimal performance gain, so the UE may only consider these APs for NCJT or SM, which may depend on the radio link quality. For example, for the APs in this category, the UE may check the radio link quality; for the APs with sufficient radio link quality, the UE may check whether SM may improve performance gain with multiple data streams will be transmitted. If so, the UE may propose AP_SP for these APs; otherwise, the UE may propose AP_NCJT for these APs. Similarly, for the APs with insufficient radio link quality, the UE may not successfully decode each radio link independently, so the UE may only propose NCJT based on combine gain in order to improve successful data reception. Thus, for the APs with large phase errors, the proposal by the UE may include three potential situations: AP_NCJT, AP_SP, or both AP_NCJT and AP_SP. With AP_NCJT and AP_SP, for APs within this category, the UE may propose AP_NCJT for some of these APs, and AP_SP for other APs.

Various example embodiments may include the APs where DL reception time difference of the UE is beyond the preconfigured CP length. For these APs, the UE may not propose that those APs serve DL transmission due to potential interference. Instead, the UE may propose AP_NO for these APs; however, if all the APs in the serving cluster are well synchronized, AP_NO may not exist.

In some example embodiments, the UE may categorize all APs within the current serving cluster into four categories: AP_CJT, AP_NCJT, AP_SP, and AP_NO. However, more transmission mechanisms may be possible, as well as categories for AP classification. The UE may recommend only one of the above four sub-clusters for each of the APs in the current serving cluster.

In addition, at 805, the UE may propose the four categories to the CPU explicitly for data transmission, based on UL signaling as shown in FIG. 2. If the UE proposes AP_CJT, the UE may also report to the CPU the corresponding phase error information for the corresponding APs. Alternatively, the UE may only report to the CPU phase error information of the slave APs, enabling the CPU to design appropriate precoding and scheduling operations to mitigate the impact of such phase errors. If the phase errors are associated with a sub-band situation, the proposals from the UE may also include such sub-band information. As a result, the proposals may allow the CPU to schedule CJT on the reported sub-band information, thereby optimizing performance for the UE.

Some example embodiments may use appropriate UL signaling so that the UE may explicitly indicate the four types of AP sub-clusters to the CPU. For example, UL signaling may be sent to the CPU by UL L1 or MAC layer signaling, depending on feedback speed required by the CPU. For L1 UL signaling, the CPU may receive the proposal from the UE as soon as possible, and take action immediately to optimize the performance. For UL L2 signaling, the CPU may receive the feedback after a time delay; however, since phase error changes may not be dynamic, layer 2 (L2) signaling may be used since L1 signaling overhead may have a greater impact on UL system coverage.

In various example embodiments, the UE may report using a structure similar to that illustrated in FIG. 2, which may include two parts: the role of the APs, and related enabling information. The first part may include a proposal from the UE on which AP should be used transmission on which strategy. The second part may include phase error information, which may be for APs proposed for CJT, or for all APs in the current serving cluster of the UE. This phase error may be on a sub-band or wideband level. If the phase error is reported on a sub-band level, the UE may also include corresponding sub-band information in the UL report, indicating to the CPU which frequency band to schedule the CJT transmission.

FIG. 4 illustrates an example of UL signaling to report the role of each AP. For the first part of FIG. 2 shown in FIG. 4, variable size signaling may include X number of fields, wherein X is the identifier of the APs in the current serving cluster. The detail value of each field may explicitly indicate the corresponding role of the AP in the following transmission. Bit per field may be determined by the supported cell-free MIMO transmission strategy. For example, three strategies may be supported, so a 2-bit per field may be sufficient to identify each strategy. The detail signal value of each field may correspond with a particular strategy, depending on the corresponding AP's role recommended by the UE. For example, 00 may indicate that the corresponding AP may conduct the CJT with other the APs marked as “00;” 01 may indicate that the corresponding APs may conduct NCJT with other APs with the same value marked as “01;” 10 may indicate that the corresponding APs may send dedicated data stream to the UE; and 11 may indicate that the corresponding APs will not send a data stream to the UE (even it is within current serving cluster).

In various example embodiments, if more transmission strategies are added to the cell-free MIMO, the number of bits per field may change as well without affecting the structure shown in FIG. 2.

The second part illustrated in FIG. 2 may include the phase error of APs recommended for CJT transmission. Alternatively, the phase error information may be reported for all slave APs, improving flexibility and providing an opportunity for the CPU to schedule CJT transmissions. Specifically, this phase error may be on sub-band level or wideband level. If on a sub-band level, the UE may include the corresponding sub-band information in this report. The CPU may then perform CJT scheduling on the corresponding sub-band to improve system performance. The detail design and required number of bits may vary after the decision on sub-band or wideband phase error, and phase error granularity.

UL signaling architecture may follow the examples depicted in FIGS. 2 and 4. As shown in FIG. 4, AP1, AP3, and the last AP may be the candidate to coherently transmit the same data stream to the UE to improve the SINR, and the UE may not change the corresponding radio link among these APs, but may combine signals for demodulation and decoding. Furthermore, AP4 may be recommended to not serve the UE, possibly due to a large phase error and/or a lack of DL SYN with other APs within the current serving cluster.

At 806, the method may include receiving indications on final decisions by the CPU to improve performance of the UE. For example, the UE may receive explicit indications of which AP will conduct which transmission strategy. For each finally selected AP, the UE may explicitly or implicitly be informed of the corresponding DMRS, which may assist the UE with optimal behavior. For example, for those APs decided for CJT, the same DMRS signal may be transmitted from these APs, and the UE may not need to distinguish each radio link between the UE and these APs. For APs to perform NCJT or SM transmissions, different DMRSs may be sent by these APs to enable the UE to differentiate each radio link from these APs. The UE may not include APs not recommended for DL transmission in the DL signaling, thereby reducing DL signaling overhead.

In various example embodiments, DMRS configuration for each AP may enable the UE to correctly perform DL reception behaviors. Each AP may be configured with at least two types of DMRS in advance, such as DMRS_CJT (one DMRS common to all APs in its serving cluster) and/or DMRS_other (different DMRS per AP to enable UE to differentiate each radio link between the APs and the UE).

Each DMRS configuration may be per UE level; thus, for each UE in a cell-free MIMO transmission situation, the CPU may configure (or reconfigure) these two types of DMRS based on the serving AP(s) list. In addition, the DMRS_CJT and DMRS_other definitions may mean that, before cell-free MIMO transmission, the UE should know which types of DMRS may be used for the following DL data reception.

The CPU may need to inform the UE of which APs may adopt which strategy by DL signaling, and may use two options (discussed in more detail that illustrated in FIG. 2 may be used to explicitly inform UE 310 which the AP may be involved in the following transmission and in which transmission strategy. Alternatively, the DL signaling may explicitly indicate the APs 320 to be involved in the following transmission, but implicitly indicate which transmission strategy may be used for these APs by indicating DMRS information. FIG. 5 depicts the first and last APs in a CJT sub-cluster being scheduled for DL CJT, while FIG. 6 depicts two APs being scheduled for NCJT.

In order to inform each UE explicitly, DL signaling may use an architecture similar to that depicted in FIG. 2. In this option, the CPU may explicitly inform the UE which APs are selected to conduct which transmission strategy to optimize system performance. One difference from FIG. 4 is the detail signaling size may be no more than that of FIG. 4. In the DL signaling, the selected AP may be indicated within the scope of the APs recommended by the UE, but may exclude those the APs marked as no transmission recommendation. Thus, DL signaling may include Y number of 2-bit fields, where Y is equal to the number of AP number recommended by the UE, excluding those APs marked as “11.” Each 2-bit field may indicate the corresponding AP's transmission strategy. 2-bit per AP may be used since no more than 3 cell-free MIMO transmission strategies may be supported. However, more transmission strategies may be added with more bits designed to indicate each AP's situation without affecting the DL signaling architecture.

When informing the UE explicitly, the CPU may mark the APs as “11,” which is within the recommendation scope of the UE, but not selected for transmission. Thus, some APs may be recommended by the UE for DL transmission, but not ultimately selected by the CPU for various reasons. The CPU may inform the UE of this information so that the UE knows from which the AP to receive the DL transmission in which mechanism.

Furthermore, informing each UE explicitly may enable decoding of the DL signaling since the UE is aware of the Y information based on its previous recommendation. Specifically, based on the previous UL signal of the UE, the UE may know the value of Y in advance, and then correctly decode the DL signaling to improve data demodulation and decoding. The DL signaling architecture is shown in FIGS. 5 and 6.

In FIG. 5, the CPU may make a final decision that the first, second, and last AP may jointly send the same data stream to the UE coherently. After the UE decodes this DL signaling, the UE may know that the same DMRS_CJT will be sent from the first, second, and last APs, and may not receive DMRS from other APs. The UE may combine the DL transmissions from these APs to do perform receiving operations.

In FIG. 6, the UE may know that only two APs are sending the same data stream jointly to the UE non-coherently, and different DMRS may be sent from these two APs. The UE may not attempt to decode information from other APs since they are marked as “11,” and not receive data transmissions from them. the UE may distinguish two radio links from these two APs by different DMRS. the UE may then demodulate these two radio links independently to soft-bit levels, and combine to improve combining gain and decoding performance. This may enable the UE to clearly identify which AP will use which transmission strategy, and perform optimal receiving functions.

Although the above two examples only indicate one transmission strategy per TTI, such a signaling structure may be very flexible to indicate hybrid transmission strategy in time domain. For example, some APs can jointly send the same data streams to the UE coherently. Furthermore, some APs may send the same data stream to the UE non-coherently, and may even support SM. This may depend on the number of antenna ports configured at the UE to support one or multiple data stream reception.

Another benefit of explicit DL signaling is that the CPU may have enough flexibility to finally determine which AP should use which transmission strategy. For example, according to the proposal by the UE, some APs may be recommended for NCJT due to their big phase errors. However, if such phase errors are known to the CPU (for example, based on reported phase error information by the UE), the CPU may help to compensate for such phase error with the precoding operation. Any such APs may be configured for CJT, which may differ from the recommendations by the UE. Instead, the CPU may indicate any differences to the UE. Despite the cost of more DL signaling overhead, each role of the APs may be indicated. If such DL signaling is sent by L2 MAC signaling, such overhead may be minimal.

Explicit indications enable indicating one transmission strategy per TTI, but such signaling structure may also be flexible to indicate hybrid transmission strategies in time domain. For example, some APs may jointly transmit the same data streams to the UE coherently. In addition, some APs may send the same data stream to the UE non-coherently and support SM. This may depend on the number of antenna ports configured at the UE to support one or multiple data stream reception.

In addition, explicit indications may provide the CPU with flexibility to determine which AP should use which transmission strategy. For example, according to the recommendation by the UE, some APs may be recommended for NCJT due to phase errors among them. If phase errors are known by the CPU, for example, based on the UE reported phase error information, the CPU may help to compensate for such phase errors with precoding operations. Such APs may be configured for CJT, which may be different from recommendations by the UE. For this situation, the CPU may clearly indicate such differences to the UE. The cost of more DL signaling overhead may clearly indicate the role of each AP. If such DL signaling is sent via L2 MAC signaling, such overhead may be insignificant.

With implicit DMRS signaling, 2-bit signal content for each field may indicate the corresponding AP assigned with which transmission strategy; the UE may then implicitly know which types of DMRS will be sent from these APs for following actions. The cost for such signaling may be 2*Y-bit signaling size to get enough flexibility for selecting APs for any types of transmission. While using implicit DMRS signaling, the recommendation by the UE may be followed for each APs role, and the CPU may only a make final decision on which APs will be involved in the following transmission; there may not be any operation to change the role of the APs. This option may also be valid and feasible since the UE understands phase error information of each AP, DL SYN status, and DL channel status information. UE 310 may recommend roles of APs that are solid and accurate enough for either CJT, NCJT, SM, or no transmission. In addition, the CPU may not try to change the recommended role for each AP, but make a final decision of whether each AP will be scheduled for transmission or not. For this option, the DL signaling design (shown in FIG. 7) may only indicate that each AP will be scheduled or not.

As shown in FIG. 7, the DL signaling design may include multiple sections based on recommendations from the UE, with each section referring to APs recommended by the UE for CJT, NCJT, and SM, respectively. Each section may include a number of fields equal to the AP number of the corresponding transmission strategy recommended by the UE before. The detail value may be 1-bit per field to indicate the corresponding AP is scheduled for the transmission or not. For example, if this bit is “1”, that means the corresponding AP is scheduled to take the UE recommended transmission strategy. On the other hand, the corresponding AP may not be incorporated into the following transmission. The total DL signal size may be Y bits, where Y is the number of APs that the UE recommended for transmission.

The technique depicted in FIG. 6 may improve receiving behavior of the UE, and may support hybrid transmission strategy execution in time domain, but with half of the signaling size compared to the technique depicted in FIG. 5. One benefit of using implicit DMRS signaling with the cost that CPU may not change the role of the AP recommended by the UE. Since the recommendation by the UE may be based on its accurate DL information, this cost may be minimal.

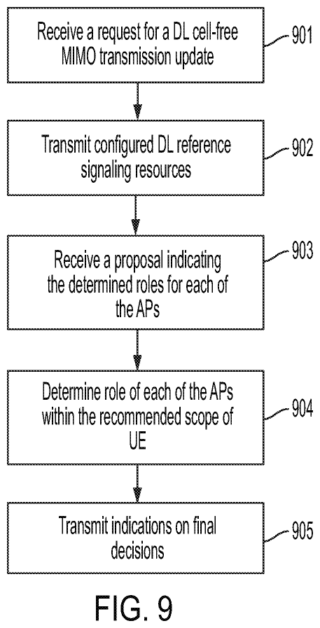

FIG. 9 illustrates an example of a flow diagram of a method that may be performed by a NE, such as NE 1010 illustrated in FIG. 10, according to various example embodiments.

As noted above, the NE, and APs and a UE (such as NE 1010 and UE 1020 illustrated in FIG. 10), may be configured to use multiple cell-free MIMO transmission strategies, such as CJT, NCJT, and SM. Although only one AP is illustrated, any number of APs may be included.

In various example embodiments, different types of AP sub-clusters may be dedicated to conduct different types of cell-free MIMO transmission strategies. For example, an AP_CJT sub-cluster may indicate that APs within this sub-cluster may conduct CJT transmissions, where all APs may transmit the same DL data stream to improve DL receiving SINR by the UE. Furthermore, it may be unnecessary for the UE to differentiate each radio link between the UE and each AP within this sub-cluster.

Furthermore, an AP_NCJT sub-cluster may indicate that the APs within this sub-cluster may conduct NCTJ transmissions, which may transmit the same DL data stream. With this sub-cluster, the UE may first differentiate each radio link between the UE and the APs of this sub-cluster; the UE may then demodulate these radio links to soft-bit levels, and combine for combining gain.

In addition, an AP_SP sub-cluster may indicate that APs within this sub-cluster conduct SM to enable multiple stream transmissions for higher throughput. For this sub-cluster, the UE may independently process each radio link without any combining action.

Similarly, an AP_NO sub-cluster may indicate that APs within this sub-cluster may not be scheduled to serve the UE within a pre-defined time period, even if the AP is within the current serving cluster. The DL transmission arriving time of these APs may be outside of the CP, and may otherwise lead to significant interference. If all APs are DL SYN, this sub-cluster may not exist, and all APs in this sub-cluster may belong to one of the first three sub-clusters.

The UE and the CPU may be aligned on the serving AP cluster determination. For example, the APs connected to the same CPU with a received RSRP above a pre-defined threshold may be selected to create a serving cluster of the UE. Within this serving cluster, type(s) of transmission strategies appropriate for each AP may be determined based on optimal system performance.

At 901, the method may include receiving a request from the UE for a DL cell-free MIMO transmission update. The request may be triggered, for example, due to a serving cluster update, radio channel quality change, and/or degradation of UE side decoding performance.

At 902, the method may include transmitting, to a UE via an AP, configured DL reference signaling resources, including the frequency domain, time domain, and code domain resource so that the UE knows when to receive which reference signals from which the APs. This action may be performed in advance. For example, the DL reference signal frequency resource and code domain information may be transmitted to the UE in advance by RRC signaling. For the time domain information notification, the UE and the CPU may be synchronized on the reference signal transmission time slot based on X+n information, where X is the time slot for UE request transmission/reception at the UE and the APs, respectively, and n may be the previous configured parameter related to the CPU and the APs link transmission delay.

In various example embodiments, the CPU may notify the UE which of the APs is the master AP; accordingly, the non-master APs within the serving cluster may then be slave APs. This information may support the UE to measure and estimate the phase error between the master AP and all slave APs. The CPU may configure each of the APs with different reference signals to distinguish each radio link between the UE and the APs. In addition, the APs may be triggered to send different reference signals simultaneously, enabling the UE to measure the phase error among the APs in a simultaneous transmission situation where the measured phase error may be accurate enough to support CJT at a later stage.

At 903, the NE may receive a proposal indicating the determined roles for each of the APs. Specifically, after the UE measures and calculates the phase error information, DL SYN status, and radio link quality information, the UE may propose a transmission strategy for the APs in order to optimize system performance.

For the APs with phase error within a preconfigured threshold, the UE may further determine the corresponding radio link quality to see whether a CJT or SM strategy should be proposed for these APs. For the APs with good radio link quality, the UE may coarsely estimate the corresponding throughput (assuming CJT or SM will be conducted respectively), and recommend these APs for the strategy with the higher throughput. For example, if CJT would lead to higher throughput than SM, the UE may recommend AP_CJT for these APs; otherwise, AP_SP may be recommended. For APs with sub-optimal radio link quality, SM may not achieve sufficient performance gain because the UE may not decode each radio link independently; thus, the UE may recommend CJT transmission for these APs to improve SINR combining gain.

For APs with small phase errors referring to the master AP, the proposal by the UE may cover three potential situations: AP_CJT, AP_SP or both AP_CJT and AP_SP. For both AP_CJT and AP_SP, some of the APs may conduct CJT transmission together, while other APs may conduct SM, independently. This hybrid cell-free MIMO transmission concept may be valid for multiple antenna ports and/or sub-arrays at the UE. For example, one antenna port may be used to receive CJT transmissions from related APs, while other ports and/or sub-arrays may be used to receive SM transmissions from the other APs.

In various example embodiments, for the APs with phase error above the preconfigured threshold, CJT may not provide optimal performance gain, so the UE may only consider these APs for NCJT or SM, which may depend on the radio link quality. For example, for the APs in this category, the UE may check the radio link quality; for the APs with sufficient radio link quality, the UE may check whether SM may improve performance gain with multiple data streams will be transmitted. If so, the UE may propose AP_SP for these APs; otherwise, the UE may propose AP_NCJT for these APs. Similarly, for the APs with insufficient radio link quality, the UE may not successfully decode each radio link independently, so the UE may only propose NCJT based on combine gain in order to improve successful data reception. Thus, for the APs with large phase errors, the proposal by the UE may include three potential situations: AP_NCJT, AP_SP, or both AP_NCJT and AP_SP. With AP_NCJT and AP_SP, for APs within this category, the UE may propose AP_NCJT for some of these APs, and AP_SP for other APs.

Various example embodiments may include the APs where DL reception time difference of the UE is beyond the preconfigured CP length. For these APs, the UE may not propose that those APs serve DL transmission due to potential interference. Instead, the UE may propose AP_NO for these APs; however, if all the APs in the serving cluster are well synchronized, AP_NO may not exist.

In some example embodiments, the UE may categorize all APs within the current serving cluster into four categories: AP_CJT, AP_NCJT, AP_SP, and AP_NO. However, more transmission mechanisms may be possible, as well as categories for AP classification. The UE may recommend only one of the above four sub-clusters for each of the APs in the current serving cluster.

In addition, at 903, the NE may receive a proposal of the four categories to the CPU explicitly for data transmission, based on UL signaling as shown in FIG. 2. If the UE proposes AP_CJT, the UE may also report to the CPU the corresponding phase error information for the corresponding APs. Alternatively, the UE may only report to the CPU phase error information of the slave APs, enabling the CPU to design appropriate precoding and scheduling operations to mitigate the impact of such phase errors. If the phase errors are associated with a sub-band situation, the proposals from the UE may also include such sub-band information. As a result, the proposals may allow the CPU to schedule CJT on the reported sub-band information, thereby optimizing performance for the UE.

Some example embodiments may use appropriate UL signaling so that the UE may explicitly indicate the four types of AP sub-clusters to the CPU. For example, UL signaling may be sent to the CPU by UL L1 or MAC layer signaling, depending on feedback speed required by the CPU. For L1 UL signaling, the CPU may receive the proposal from the UE as soon as possible, and take action immediately to optimize the performance. For UL L2 signaling, the CPU may receive the feedback after a time delay; however, since phase error changes may not be dynamic, layer 2 (L2) signaling may be used since L1 signaling overhead may have a greater impact on UL system coverage.

In various example embodiments, the UE may report using a structure similar to that illustrated in FIG. 2, which may include two parts: the role of the APs, and related enabling information. The first part may include a proposal from the UE on which AP should be used transmission on which strategy. The second part may include phase error information, which may be for APs proposed for CJT, or for all APs in the current serving cluster of the UE. This phase error may be on a sub-band or wideband level. If the phase error is reported on a sub-band level, the UE may also include corresponding sub-band information in the UL report, indicating to the CPU which frequency band to schedule the CJT transmission.

FIG. 4 illustrates an example of UL signaling to report the role of each AP. For the first part shown in FIG. 4, variable size signaling may include X number of fields, wherein X is the identifier of the APs in the current serving cluster. The detail value of each field may explicitly indicate the corresponding role of the AP in the following transmission. Bit per field may be determined by the supported cell-free MIMO transmission strategy. For example, three strategies may be supported, so a 2-bit per field may be sufficient to identify each strategy. The detail signal value of each field may correspond with a particular strategy, depending on the corresponding AP's role recommended by the UE. For example, 00 may indicate that the corresponding AP may conduct the CJT with other the APs marked as “00;” 01 may indicate that the corresponding APs may conduct NCJT with other APs with the same value marked as “01;” 10 may indicate that the corresponding APs may send dedicated data stream to the UE; and 11 may indicate that the corresponding APs will not send a data stream to the UE (even it is within current serving cluster).

In various example embodiments, if more transmission strategies are added to the cell-free MIMO, the number of bits per field may change as well without affecting the structure shown in FIG. 2.

The second part illustrated in FIG. 2 may include the phase error of APs recommended for CJT transmission. Alternatively, the phase error information may be reported for all slave APs, improving flexibility and providing an opportunity for the CPU to schedule CJT transmissions. Specifically, this phase error may be on sub-band level or wideband level. If on a sub-band level, the UE may include the corresponding sub-band information in this report. The CPU may then perform CJT scheduling on the corresponding sub-band to improve system performance. The detail design and required number of bits may vary after the decision on sub-band or wideband phase error, and phase error granularity.

UL signaling architecture may follow the examples depicted in FIGS. 2 and 4. As shown in FIG. 4, AP1, AP3, and the last AP may be the candidate to coherently transmit the same data stream to the UE to improve the SINR, and the UE may not change the corresponding radio link among these APs, but may combine signals for demodulation and decoding. Furthermore, AP4 may be recommended to not serve the UE, possibly due to a large phase error and/or a lack of DL SYN with other APs within the current serving cluster.

At 904, after the CPU receives the proposals from the UE, the method may further include determining the role of each of the APs which is within the recommended scope of the UE. The role of each of the APs may be determined based upon at least one of the strategy and enabling information received from the user equipment at 805. Additionally, channel quality information of each UE already available at the CPU may be taken into account when determining the role of each of the APs, either alone or in combination other information. For example, as shown in FIG. 4, the CPU may consider the load and resource situations of each AP and/or side antenna port configuration of the UE, and determine which transmission strategy(ies) may be assigned to each AP. The CPU may then determine the corresponding demodulation reference signal (DMRS) for each selected AP.

At 905, the method may include transmitting indications on final decisions by the CPU to improve performance to the UE. For example, the NE may transmit explicit indications of which AP will conduct which transmission strategy. For each finally selected AP, the UE may explicitly or implicitly be informed of the corresponding DMRS, which may assist the UE with optimal behavior. For example, for those APs decided for CJT, the same DMRS signal may be transmitted from these APs, and the UE may not need to distinguish each radio link between the UE and these APs. For APs to perform NCJT or SM transmissions, different DMRSs may be sent by these APs to enable the UE to differentiate each radio link from these APs. The UE may not include APs not recommended for DL transmission in the DL signaling, thereby reducing DL signaling overhead.

In various example embodiments, DMRS configuration for each AP may enable the UE to correctly perform DL reception behaviors. Each AP may be configured with at least two types of DMRS in advance, such as DMRS_CJT (one DMRS common to all APs in its serving cluster) and/or DMRS_other (different DMRS per AP to enable UE to differentiate each radio link between the APs and the UE).

Each DMRS configuration may be per UE level; thus, for each UE in a cell-free MIMO transmission situation, the CPU may configure (or reconfigure) these two types of DMRS based on the serving AP(s) list. In addition, the DMRS_CJT and DMRS_other definitions may mean that, before cell-free MIMO transmission, the UE should know which types of DMRS may be used for the following DL data reception.

The CPU may need to inform the UE of which APs may adopt which strategy by DL signaling, and may use two options (discussed in more detail below) to perform corresponding DL signaling. First, DL signaling similar to that illustrated in FIG. 2 may be used to explicitly inform UE 310 which the AP may be involved in the following transmission and in which transmission strategy. Alternatively, the DL signaling may explicitly indicate the APs 320 to be involved in the following transmission, but implicitly indicate which transmission strategy may be used for these APs by indicating DMRS information. FIG. 5 depicts the first and last APs in a CJT sub-cluster being scheduled for DL CJT, while FIG. 6 depicts two APs being scheduled for NCJT.

In order to inform each UE explicitly, DL signaling may use an architecture similar to that depicted in FIG. 2. In this option, the CPU may explicitly inform the UE which APs are selected to conduct which transmission strategy to optimize system performance. One difference from FIG. 4 is the detail signaling size may be no more than that of FIG. 4. In the DL signaling, the selected AP may be indicated within the scope of the APs recommended by the UE, but may exclude those the APs marked as no transmission recommendation. Thus, DL signaling may include Y number of 2-bit fields, where Y is equal to the number of AP number recommended by the UE, excluding those APs marked as “11.” Each 2-bit field may indicate the corresponding AP's transmission strategy. 2-bit per AP may be used since no more than 3 cell-free MIMO transmission strategies may be supported. However, more transmission strategies may be added with more bits designed to indicate each AP's situation without affecting the DL signaling architecture.

When informing the UE explicitly, the CPU may mark the APs as “11,” which is within the recommendation scope of the UE, but not selected for transmission. Thus, some APs may be recommended by the UE for DL transmission, but not ultimately selected by the CPU for various reasons. The CPU may inform the UE of this information so that the UE knows from which the AP to receive the DL transmission in which mechanism.

Furthermore, informing each UE explicitly may enable decoding of the DL signaling since the UE is aware of the Y information based on its previous recommendation. Specifically, based on the previous UL signal of the UE, the UE may know the value of Y in advance, and then correctly decode the DL signaling to improve data demodulation and decoding. The DL signaling architecture is shown in FIGS. 5 and 6.

In FIG. 5, the CPU may make a final decision that the first, second, and last AP may jointly send the same data stream to the UE coherently. After the UE decodes this DL signaling, the UE may know that the same DMRS_CJT will be sent from the first, second, and last APs, and may not receive DMRS from other APs. The UE may combine the DL transmissions from these APs to do perform receiving operations.

In FIG. 6, the UE may know that only two APs are sending the same data stream jointly to the UE non-coherently, and different DMRS may be sent from these two APs. The UE may not attempt to decode information from other APs since they are marked as “11,” and not receive data transmissions from them. The UE may distinguish two radio links from these two APs by different DMRS. the UE may then demodulate these two radio links independently to soft-bit levels, and combine to improve combining gain and decoding performance. This may enable the UE to clearly identify which AP will use which transmission strategy, and perform optimal receiving functions.

Although the above two examples only indicate one transmission strategy per TTI, such a signaling structure may be very flexible to indicate hybrid transmission strategy in time domain. For example, some APs can jointly send the same data streams to the UE coherently. Furthermore, some APs may send the same data stream to the UE non-coherently, and may even support SM. This may depend on the number of antenna ports configured at the UE to support one or multiple data stream reception.

Another benefit of explicit DL signaling is that the CPU may have enough flexibility to finally determine which AP should use which transmission strategy. For example, according to the proposal by the UE, some APs may be recommended for NCJT due to their big phase errors. However, if such phase errors are known to the CPU (for example, based on reported phase error information by the UE), the CPU may help to compensate for such phase error with the precoding operation. Any such APs may be configured for CJT, which may differ from the recommendations by the UE. Instead, the CPU may indicate any differences to the UE. Despite the cost of more DL signaling overhead, each role of the APs may be indicated. If such DL signaling is sent by L2 MAC signaling, such overhead may be minimal.

Explicit indications enable indicating one transmission strategy per TTI, but such signaling structure may also be flexible to indicate hybrid transmission strategies in time domain. For example, some APs may jointly transmit the same data streams to the UE coherently. In addition, some APs may send the same data stream to the UE non-coherently and support SM. This may depend on the number of antenna ports configured at the UE to support one or multiple data stream reception.

In addition, explicit indications may provide the CPU with flexibility to determine which AP should use which transmission strategy. For example, according to the recommendation by the UE, some APs may be recommended for NCJT due to phase errors among them. If phase errors are known by the CPU, for example, based on the UE reported phase error information, the CPU may help to compensate for such phase errors with precoding operations. Such APs may be configured for CJT, which may be different from recommendations by the UE. For this situation, the CPU may clearly indicate such differences to the UE. The cost of more DL signaling overhead may clearly indicate the role of each AP. If such DL signaling is sent via L2 MAC signaling, such overhead may be insignificant.

With implicit DMRS signaling, 2-bit signal content for each field may indicate the corresponding AP assigned with which transmission strategy; the UE may then implicitly know which types of DMRS will be sent from these APs for following actions. The cost for such signaling may be 2*Y-bit signaling size to get enough flexibility for selecting APs for any types of transmission. While using implicit DMRS signaling, the recommendation by the UE may be followed for each APs role, and the CPU may only a make final decision on which APs will be involved in the following transmission; there may not be any operation to change the role of the APs. This option may also be valid and feasible since the UE understands phase error information of each AP, DL SYN status, and DL channel status information. UE 310 may recommend roles of APs that are solid and accurate enough for either CJT, NCJT, SM, or no transmission. In addition, the CPU may not try to change the recommended role for each AP, but make a final decision of whether each AP will be scheduled for transmission or not. For this option, the DL signaling design (shown in FIG. 7) may only indicate that each AP will be scheduled or not.

As shown in FIG. 7, the DL signaling design may include multiple sections based on recommendations from the UE, with each section referring to APs recommended by the UE for CJT, NCJT, and SM, respectively. Each section may include a number of fields equal to the AP number of the corresponding transmission strategy recommended by the UE before. The detail value may be 1-bit per field to indicate the corresponding AP is scheduled for the transmission or not. For example, if this bit is “1”, that means the corresponding AP is scheduled to take the UE recommended transmission strategy. On the other hand, the corresponding AP may not be incorporated into the following transmission. The total DL signal size may be Y bits, where Y is the number of APs that the UE recommended for transmission.

The technique depicted in FIG. 6 may improve receiving behavior of the UE, and may support hybrid transmission strategy execution in time domain, but with half of the signaling size compared to the technique depicted in FIG. 5. One benefit of using implicit DMRS signaling with the cost that CPU may not change the role of the AP recommended by the UE. Since the recommendation by the UE may be based on its accurate DL information, this cost may be minimal.

FIG. 10 illustrates an example of a system according to certain example embodiments. In one example embodiment, a system may include multiple devices, such as, for example, NE 1010 and/or UE 1020.

NE 1010 may be one or more of a base station, such as an eNB or gNB, a serving gateway, a server, and/or any other access node or combination thereof.

NE 1010 may further comprise at least one gNB-CU, which may be associated with at least one gNB-DU. The at least one gNB-CU and the at least one gNB-DU may be in communication via at least one F1 interface, at least one Xₙ-C interface, and/or at least one NG interface via a 5GC.

UE 1020 may include one or more of a mobile device, such as a mobile phone, smart phone, personal digital assistant (PDA), tablet, or portable media player, digital camera, pocket video camera, video game console, navigation unit, such as a global positioning system (GPS) device, desktop or laptop computer, single-location device, such as a sensor or smart meter, or any combination thereof. Furthermore, NE 1010 and/or UE 1020 may be one or more of a citizens broadband radio service device (CBSD).

NE 1010 and/or UE 1020 may include at least one processor, respectively indicated as 1011 and 1021. Processors 1011 and 1021 may be embodied by any computational or data processing device, such as a central processing unit (CPU), application specific integrated circuit (ASIC), or comparable device. The processors may be implemented as a single controller, or a plurality of controllers or processors.

At least one memory may be provided in one or more of the devices, as indicated at 1012 and 1022. The memory may be fixed or removable. The memory may include computer program instructions or computer code contained therein. Memories 1012 and 1022 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate from the one or more processors. Furthermore, the computer program instructions stored in the memory, and which may be processed by the processors, may be any suitable form of computer program code, for example, a compiled or interpreted computer program written in any suitable programming language.

Processors 1011 and 1021, memories 1012 and 1022, and any subset thereof, may be configured to provide means corresponding to the various blocks of FIGS. 3-9. Although not shown, the devices may also include positioning hardware, such as GPS or micro electrical mechanical system (MEMS) hardware, which may be used to determine a location of the device. Other sensors are also permitted, and may be configured to determine location, elevation, velocity, orientation, and so forth, such as barometers, compasses, and the like.

As shown in FIG. 10, transceivers 1013 and 1023 may be provided, and one or more devices may also include at least one antenna, respectively illustrated as 1014 and 1024. The device may have many antennas, such as an array of antennas configured for multiple input multiple output (MIMO) communications, or multiple antennas for multiple RATs. Other configurations of these devices, for example, may be provided. Transceivers 1013 and 1023 may be a transmitter, a receiver, both a transmitter and a receiver, or a unit or device that may be configured both for transmission and reception.

The memory and the computer program instructions may be configured, with the processor for the particular device, to cause a hardware apparatus, such as UE, to perform any of the processes described above (i.e., FIGS. 3-9). Therefore, in certain example embodiments, a non-transitory computer-readable medium may be encoded with computer instructions that, when executed in hardware, perform a process such as one of the processes described herein. Alternatively, certain example embodiments may be performed entirely in hardware.

In certain example embodiments, an apparatus may include circuitry configured to perform any of the processes or functions illustrated in FIGS. 3-9. For example, circuitry may be hardware-only circuit implementations, such as analog and/or digital circuitry. In another example, circuitry may be a combination of hardware circuits and software, such as a combination of analog and/or digital hardware circuitry with software or firmware, and/or any portions of hardware processors with software (including digital signal processors), software, and at least one memory that work together to cause an apparatus to perform various processes or functions. In yet another example, circuitry may be hardware circuitry and or processors, such as a microprocessor or a portion of a microprocessor, that includes software, such as firmware, for operation. Software in circuitry may not be present when it is not needed for the operation of the hardware.

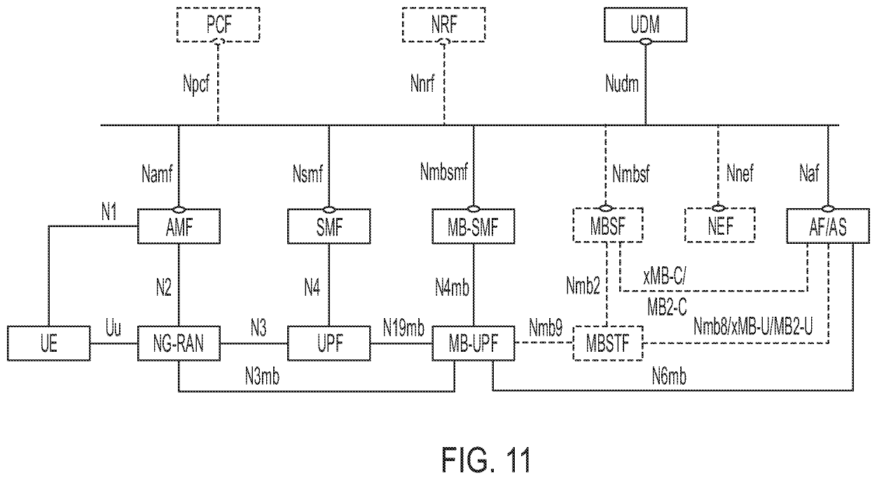

FIG. 11 illustrates an example of a 5G network and system architecture according to certain example embodiments. Shown are multiple network functions that may be implemented as software operating as part of a network device or dedicated hardware, as a network device itself or dedicated hardware, or as a virtual function operating as a network device or dedicated hardware. The NE and UE illustrated in FIG. 11 may be similar to NE 1010 and UE 1020, respectively. The user plane function (UPF) may provide services such as intra-RAT and inter-RAT mobility, routing and forwarding of data packets, inspection of packets, user plane quality of service (QoS) processing, buffering of downlink packets, and/or triggering of downlink data notifications. The application function (AF) may primarily interface with the core network to facilitate application usage of traffic routing and interact with the policy framework.

According to certain example embodiments, processors 1011 and 1021, and memories 1012 and 1022, may be included in or may form a part of processing circuitry or control circuitry. In addition, in some example embodiments, transceivers 1013 and 1023 may be included in or may form a part of transceiving circuitry.

In some example embodiments, an apparatus (e.g., NE 1010 and/or UE 1020) may include means for performing a method, a process, or any of the variants discussed herein. Examples of the means may include one or more processors, memory, controllers, transmitters, receivers, and/or computer program code for causing the performance of the operations.

In various example embodiments, apparatus 1020 may be controlled by memory 1022 and processor 1021 to receive a downlink reference signal, determine at least one cell-free multiple input multiple output transmission strategy associated with at least one access point based upon at least the downlink reference signal, and transmit to a network entity at least one of the at least one cell-free multiple input multiple output transmission strategy and enabling information.

Certain example embodiments may be directed to an apparatus that includes means for performing any of the methods described herein including, for example, means for receiving a downlink reference signal. The apparatus may further include means for determining at least one cell-free multiple input multiple output transmission strategy associated with at least one access point based upon at least the downlink reference signal. The apparatus may further include means for transmitting to a network entity at least one of the at least one cell-free multiple input multiple output transmission strategy and enabling information.

In various example embodiments, apparatus 1010 may be controlled by memory 1012 and processor 1011 to transmit at least one downlink reference signal to a user equipment, receive at least one cell-free multiple input multiple output transmission strategy from the user equipment, determine a role of each of a plurality of access points based upon at least one of the strategy and enabling information from the user equipment, and transmit an indication of an association between each of the plurality of access points and the strategy to the user equipment.

Certain example embodiments may be directed to an apparatus that includes means for performing any of the methods described herein including, for example, means for transmitting at least one downlink reference signal to a user equipment. The apparatus may further include means for receiving at least one cell-free multiple input multiple output transmission strategy from the user equipment. The apparatus may further include means for determining a role of each of a plurality of access points based upon at least one of the strategy and enabling information from the user equipment. The apparatus may further include means for transmitting an indication of an association between each of the plurality of access points and the strategy to the user equipment.

The features, structures, or characteristics of example embodiments described throughout this specification may be combined in any suitable manner in one or more example embodiments. For example, the usage of the phrases “various embodiments,” “certain embodiments,” “some embodiments,” or other similar language throughout this specification refers to the fact that a particular feature, structure, or characteristic described in connection with an example embodiment may be included in at least one example embodiment. Thus, appearances of the phrases “in various embodiments,” “in certain embodiments,” “in some embodiments,” or other similar language throughout this specification does not necessarily all refer to the same group of example embodiments, and the described features, structures, or characteristics may be combined in any suitable manner in one or more example embodiments.

Additionally, if desired, the different functions or procedures discussed above may be performed in a different order and/or concurrently with each other. Furthermore, if desired, one or more of the described functions or procedures may be optional or may be combined. As such, the description above should be considered as illustrative of the principles and teachings of certain example embodiments, and not in limitation thereof.

One having ordinary skill in the art will readily understand that the example embodiments discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of the example embodiments.

### Partial Glossary

3GPP Third Generation Partnership Project
5G Fifth Generation
5GC Fifth Generation Core
5GS Fifth Generation System
6G Sixth Generation
AMF Access and Mobility Management Function
AP Access Point
ASIC Application Specific Integrated Circuit
BS Base Station
CBSD Citizens Broadband Radio Service Device
CE Control Elements
CG Configured Grant
CJT Coherent Joint Transmission
CN Core Network
CP Cyclic Prefix
CPU Central Processing Unit
DCI Downlink Control Information
DL Downlink
DMRS Demodulation Reference Signal
DRB Data Radio Bearer
DU Distributed Unit
eMBB Enhanced Mobile Broadband
eMTC Enhanced Machine Type Communication
eNB Evolved Node B
EPS Evolved Packet System
FDD Frequency Division Duplex
FR Frequency Range
gNB Next Generation Node B
GPS Global Positioning System
HDD Hard Disk Drive
IoT Internet of Things
L1 Layer 1
L2 Layer 2
LTE Long-Term Evolution
LTE-A Long-Term Evolution Advanced
MAC Medium Access Control
MBS Multicast and Broadcast Systems
MC Multicast
MCS Modulation and Coding Scheme
MEMS Micro Electrical Mechanical System
MIMO Multiple Input Multiple Output
MME Mobility Management Entity
mMTC Massive Machine Type Communication
mmW Millimeter
NAS Non-Access Stratum
NB-IoT Narrowband Internet of Things
NCJT Non-Coherent Joint Transmission
NE Network Entity
NG Next Generation
NG-eNB Next Generation Evolved Node B
NG-RAN Next Generation Radio Access Network
NR New Radio
NR-U New Radio Unlicensed
PBR Prioritized Bit Rate
PDA Personal Digital Assistance
PHY Physical
QoS Quality of Service
RAM Random Access Memory
RAN Radio Access Network
RAT Radio Access Technology
RE Resource Element
RF Radio Frequency
RRC Radio Resource Control
RS Reference Signal
RSRP Reference Signal Received Power
SINR Signal to Interference Plus Noise Ratio
SM Spatial Multiplexing
SR Scheduling Report
SYN Synchronization
TDD Time Division Duplex
TTI Transmission Time Interval
Tx Transmission
UE User Equipment
UL Uplink
UMTS Universal Mobile Telecommunications System
UPF User Plane Function
URLLC Ultra-Reliable and Low-Latency Communication
UTRAN Universal Mobile Telecommunications System Terrestrial Radio Access Network
WLAN Wireless Local Area Network

1.-39. (canceled)

40. A method, comprising:
receiving, by a user equipment, a downlink reference signal;
determining, by the user equipment, at least one cell-free multiple input multiple output transmission strategy associated with at least one access point based upon at least the downlink reference signal; and
transmitting, by the user equipment, to a network entity at least one of the at least one cell-free multiple input multiple output transmission strategy and enabling information.

41. The method of claim 40, wherein the enabling information comprises phase error information configured for at least one of coherent joint transmission proposed for access points or for all access points within a current serving cluster of the user equipment.

42. The method of claim 40, wherein the at least one cell-free multiple input multiple output transmission strategies are associated with at least one of coherent joint transmission, non-coherent joint transmission, spatial multiplexing, or undefined transmission strategy.

43. The method of claim 40, further comprising:
transmitting, by the user equipment, a request for a downlink cell-free multiple input multiple output transmission update.

44. The method of claim 40, further comprising:
receiving, by the user equipment, different downlink wide band reference signal transmissions simultaneously.

45. The method of claim 40, further comprising:
receiving, by the user equipment, an indication of an association between each of the plurality of access points with a transmission strategy.

46. An apparatus, comprising:
at least one processor; and
at least one memory including computer program code,
wherein the at least one memory and the computer program code are configured to, with the at least one processor, cause the apparatus at least to:
receive a downlink reference signal;
determine at least one cell-free multiple input multiple output transmission strategy associated with at least one access point based upon at least the downlink reference signal; and
transmit to a network entity at least one of the at least one cell-free multiple input multiple output transmission strategy and enabling information.

47. The apparatus of claim 46, wherein the enabling information comprises phase error information configured for at least one of coherent joint transmission proposed for access points or for all access points within a current serving cluster of the apparatus.

48. The apparatus of claim 46, wherein the at least one cell-free multiple input multiple output transmission strategies are associated with at least one of coherent joint transmission, non-coherent joint transmission, spatial multiplexing, or undefined transmission strategy.

49. The apparatus of claim 46, wherein the at least one memory and the computer program code are further configured to, with the at least one processor, cause the apparatus at least to:
transmit a request for a downlink cell-free multiple input multiple output transmission update.

50. The apparatus of claim 46, wherein the at least one memory and the computer program code are further configured to, with the at least one processor, cause the apparatus at least to:
receive different downlink wide band reference signal transmissions simultaneously.

51. The apparatus of claim 46, wherein the at least one memory and the computer program code are further configured to, with the at least one processor, cause the apparatus at least to:
estimate phase error, radio link quality, or other relevant information for each of the plurality of access points.

52. The apparatus of claim 46, wherein the at least one memory and the computer program code are further configured to, with the at least one processor, cause the apparatus at least to:
receive an indication of an association between each of the plurality of access points with a transmission strategy.

53. An apparatus, comprising:
means for receiving a downlink reference signal;
means for determining at least one cell-free multiple input multiple output transmission strategy associated with at least one access point based upon at least the downlink reference signal; and
means for transmitting to a network entity at least one of the at least one cell-free multiple input multiple output transmission strategy and enabling information.

54. The apparatus of claim 53, wherein the enabling information comprises phase error information configured for at least one of coherent joint transmission proposed for access points or for all access points within a current serving cluster of the apparatus.

55. The apparatus of claim 53, wherein the at least one cell-free multiple input multiple output transmission strategies are associated with at least one of coherent joint transmission, non-coherent joint transmission, spatial multiplexing, or undefined transmission strategy.

56. The apparatus of claim 53, further comprising:
means for transmitting a request for a downlink cell-free multiple input multiple output transmission update.

57. The apparatus of claim 53, further comprising:
means for receiving different downlink wide band reference signal transmissions simultaneously.

58. The apparatus of claim 53, further comprising:
means for estimating phase error, radio link quality, or other relevant information for each of the plurality of access points.

59. The apparatus of claim 53, further comprising:
means for receiving an indication of an association between each of the plurality of access points with a transmission strategy.
